(19) United States
(12) Patent Application Publication
(10) Pub. No.: US 2012/0196464 A1
(43) Pub. Date: Aug. 2, 2012

(54) WATER SEAL CONNECTOR

(76) Inventor: Yueh Chiung Lu, Heng Feng Village (TW)

(21) Appl. No.: 13/017,631

(22) Filed: Jan. 31, 2011

(51) Int. Cl. H01R 13/52

(52) U.S. Cl. 439/277

(57) ABSTRACT

Installed in a signal receiving device for the connection of a coaxial cable connector, a water-seal connector is disclosed to include a base block, a connection component extended out of the base block and fastened up with a locknut of the coaxial cable connector, a flexible ring gasket, a cushion pad and a spring washer mounted in proper order amount the connection component and stopped between the locknut and the base block to achieve an excellent water sealing effect. The flexible ring gasket has an axially inwardly extending annular packing portion and a radially inwardly extending annular stop face defined therein and water-tightly wrapped about an outer race and outer end edge of the locknut.

### BACKGROUND OF THE INVENTION

1. Field of the Invention

The present invention relates to a connector for use in a signal receiving device, such as splitter, outdoor tap, low noise block or female splice adapter, for the connection of a coaxial cable connector and more particularly, to a water seal connector, which fits different coaxial cable connectors from different manufacturers for quick installation, and achieves an excellent water sealing effect during application.

2. Description of the Related Art

Coaxial cable is commonly used in cable TV systems for signal transmission. A coaxial cable has the advantage of being practical for use in a cable TV system for two-way network signal transmission.

During application, a coaxial cable is mounted with a cable-end connector (coaxial cable connector) for connection to a mating connector at a signal receiving device, such as splitter, outdoor tap, low noise block or female splice adapter, for signal transmission. If a coaxial cable connector is disposed outdoors, a water sealing measure is necessary. At this time, a water seal member may be used and attached to the connection area between the coaxial cable connector and the mating connector.

FIG. 1 illustrates a conventional water-sealing coaxial cable connector A. According to this design, the locknut A2 of the water-sealing coaxial cable connector A is peripherally mounted with a hexagonal rubber water seal ring A1. When connecting the water-sealing coaxial cable connector A to the mating connector C, the water-sealing coaxial cable connector A is rotated with the hexagonal rubber water seal ring A1 and threaded onto the connection component C1 of the mating connector C, and then the hexagonal rubber water seal ring A1 is pushed forwards by the user's fingers toward the mating connector C, as indicated by the arrowhead sign G1. When the hexagonal rubber water seal ring A1 is stopped against the base block of the mating connector C, the installation is done. Because the hexagonal rubber water seal ring A1 is a flexible member, it is difficult to move the hexagonal rubber water seal ring A1 toward the base block of the mating connector C. When moving the hexagonal rubber water seal ring A1 toward the base block of the mating connector C, the user must apply much force to the hexagonal rubber water seal ring A1. Therefore, this design is inconvenient to install.

FIG. 2 illustrates another design of prior art water-sealing coaxial cable connector B. According to this design, a rubber ring gasket B1 is attached to the outside wall of the locknut B2 of the water-sealing coaxial cable connector B. When connecting the water-sealing coaxial cable connector B to a mating connector C, press-fit the rubber ring gasket B1 onto the threaded connection component C1 of the mating connector C, and then rotating the locknut B2 of the water-sealing coaxial cable connector B toward the threaded connection component C1 to thread the inner thread of the water-sealing coaxial cable connector B onto the outer thread of the threaded connection component C1. When rotating the locknut B2 onto the threaded connection component C1, a resistance will be produced between an outer race B21 of the locknut B2 and a packing portion B11 of the rubber ring gasket B1, hindering installation. Thus, the installation of this design of water-sealing coaxial cable connector B requires much effort.

FIG. 3 illustrates still another prior art design of water-sealing coaxial cable connector D. According to this design, the water-sealing coaxial cable connector D comprises a locknut D2, and a tubular rubber seal member D1 attached to the front side of the locknut D2. The locknut D2 defines a mounting groove D21 extending around the periphery and a locating flange D22 disposed at the front side of the mounting groove D21. The tubular rubber seal member D1 has an inwardly flanged mounting portion D10 located on its one end and attached to the mounting groove D21 of the locknut D2. Further, an embossed copper packing ring D3 is fastened to the outside wall of the locknut D2 and pressed against the periphery of one end of the tubular rubber seal member D1 to hold down the inwardly flanged mounting portion D10 of the tubular rubber seal member D1 in the mounting groove D21 of the locknut D2.

When connecting the water-sealing coaxial cable connector D to a mating connector C, sleeve the tubular rubber seal member D1 onto a connection component C1 of the mating connector C, and then rotate the embossed copper packing ring D3 with the fingers to thread the locknut D2 onto the connection component C1 of the mating connector C. Thus, the tubular rubber seal member D1 provides a water seal effect.

According to this design, the extra embossed copper packing ring D3 greatly increases the cost of the water-sealing coaxial cable connector D. It is not economic to use this design of water-seal coaxial cable connector.

In view of the drawbacks of the aforesaid various prior art design, there is a strong demand to provide a water-seal connector for use in a signal receiving device with a coaxial cable connector, which eliminates the drawbacks of the aforesaid prior art designs, facilitating installation and saving the installation cost.

### SUMMARY OF THE INVENTION

The present invention has been accomplished under the circumstances in view. It is one object of the present invention to provide a water-seal connector for use in a signal receiving device, such as splitter, outdoor tap, low noise block or female splice adapter, for the connection of a coaxial cable connector, which fits different coaxial cable connectors from different manufacturers for quick installation, and achieves an excellent water sealing effect during application.

To achieve this and other objects of the present invention, a water-seal connector is used in a signal receiving device for the connection of a locknut of a coaxial cable connector. The locknut of the coaxial cable connector defines an outer race and an outer end edge at a front side thereof. The water-seal connector comprises a base block, which is mounted in the signal receiving device, having an outer wall protruded over one side of the signal receiving device; a cylindrical connection component, which extends out of the base block, comprising a smooth surface portion at a proximal end thereof adjacent to the base block and an outer thread at a distal end thereof for engagement with an inner thread of the locknut of the coaxial cable connector for enabling a metal center conductor of the coaxial cable connector to be inserted into the cylindrical connection component for signal transmission; a spring washer, which is mounted around the cylindrical connection component, having a part of one side thereof stopped against the base block; a cushion ring, which is mounted around the cylindrical connection component and stopped against a part of an opposite side of the spring washer; a flexible ring gasket, which is mounted around the cylindrical connection component, having a first end stopped against one side of the cushion ring, a second end opposite to the first end, a length defined between the first end and the second end and being shorter than the cylindrical connection component, an inner hole cut through the first end and the second end and press-fitted onto the cylindrical connection component, an axially inwardly extending annular packing portion defined in the second end and adapted for receiving the outer race of the locknut of the coaxial cable connector and a radially inwardly extending annular stop face defined in the second end and perpendicularly extended from the axially inwardly extending annular packing portion and adapted for stopping against the outer end edge of the locknut of the coaxial cable connector.

When the water-seal connector is connected with the locknut of any commercial coaxial cable connector, the axially inwardly extending annular packing portion and radially inwardly extending annular stop face of the flexible ring gasket are respectively stopped against the outer race and outer end edge of the locknut, and the inner hole is press-fitted onto the smooth surface portion of the connection component, and at this time, the locknut imparts a pressure to the flexible ring gasket against the cushion ring and the spring washer, and the spring washer renders a reaction force to the cushion ring against the flexible ring gasket. Therefore, the water-seal connector fits and seals any of a variety of commercial coaxial cable connectors from different manufacturers.

Further, the spring washer can be made having an arched profile, or shaped like a bowl, corrugated ring.

### BRIEF DESCRIPTION OF THE DRAWINGS

FIG. 1 is a sectional side view illustrating a prior art water-sealing coaxial cable connector connected with a mating.

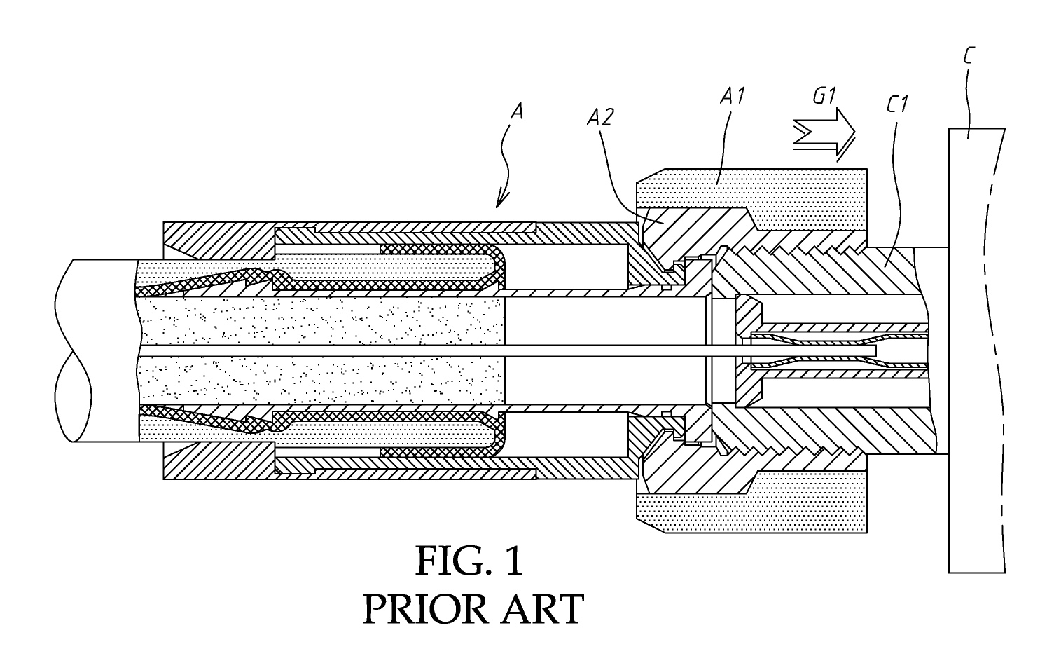

FIG. 2 is a sectional side view illustrating another design of prior art water-sealing coaxial cable connector connected with a mating.

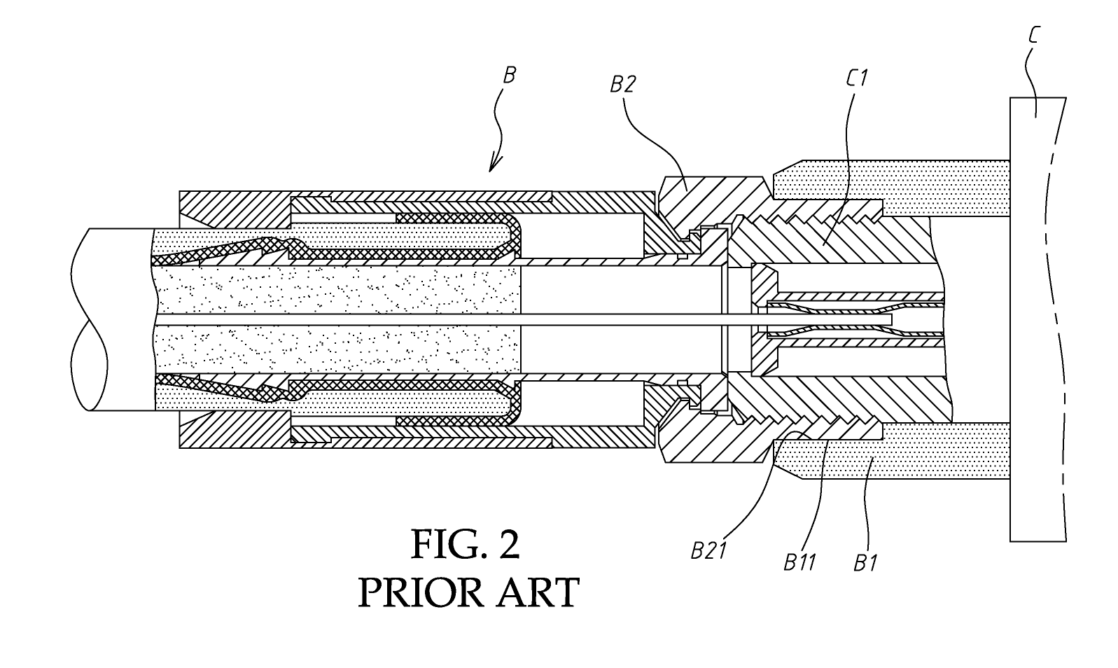

FIG. 3 is a sectional side view illustrating still another design of prior art mating connector connected with a coaxial cable connector.

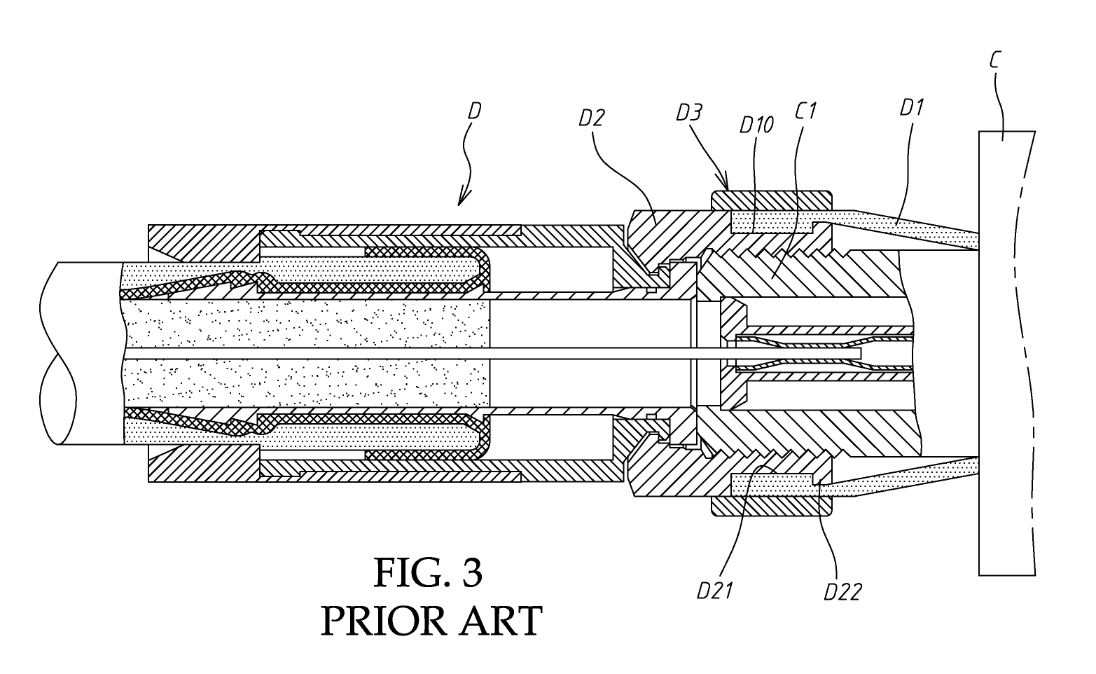

FIG. 4 is an exploded view of a water-seal connector in accordance with the present invention.

FIG. 5 is a sectional elevational assembly view of the water-seal connector in accordance with the present invention.

FIG. 6 is a sectional side view of the water-seal connector in accordance with the present invention.

FIG. 7 is a schematic sectional side view of the present invention, illustrating a coaxial cable connector connected to the water-seal connector.

FIG. 8 is a schematic sectional side view of the present invention, illustrating a coaxial cable connector connected to an alternate form of the water-seal connector.

FIG. 9 is an enlarged view of part A of FIG. 8.

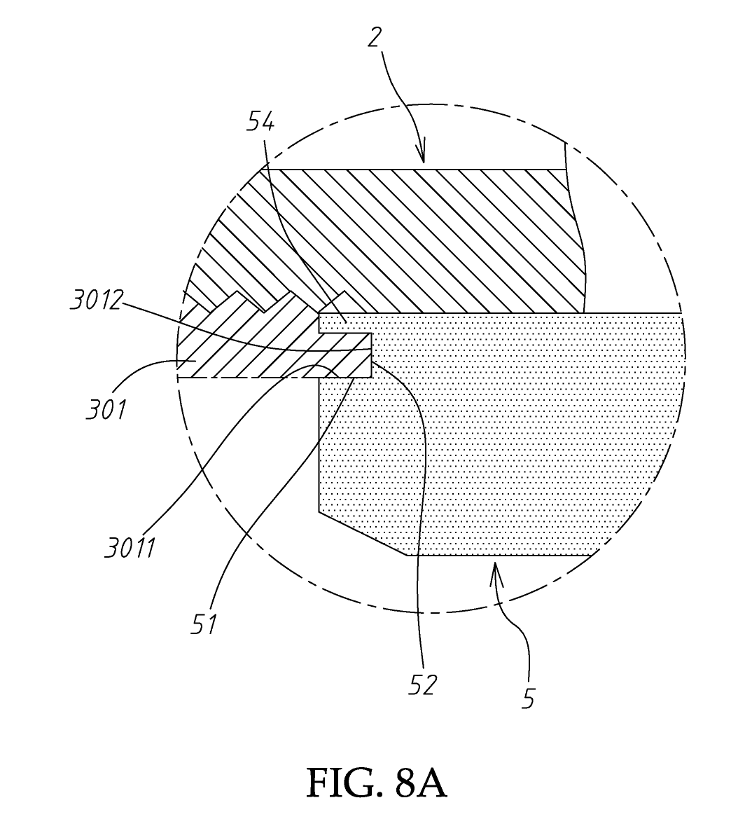

### DETAILED DESCRIPTION OF THE PREFERRED EMBODIMENT

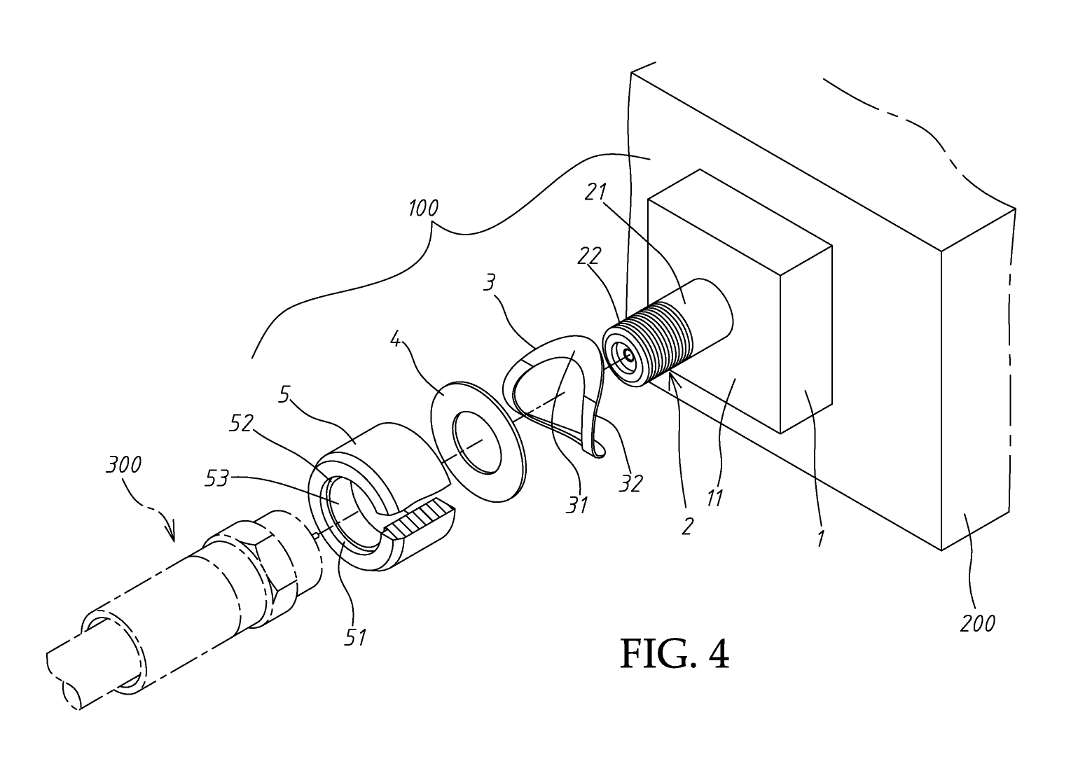

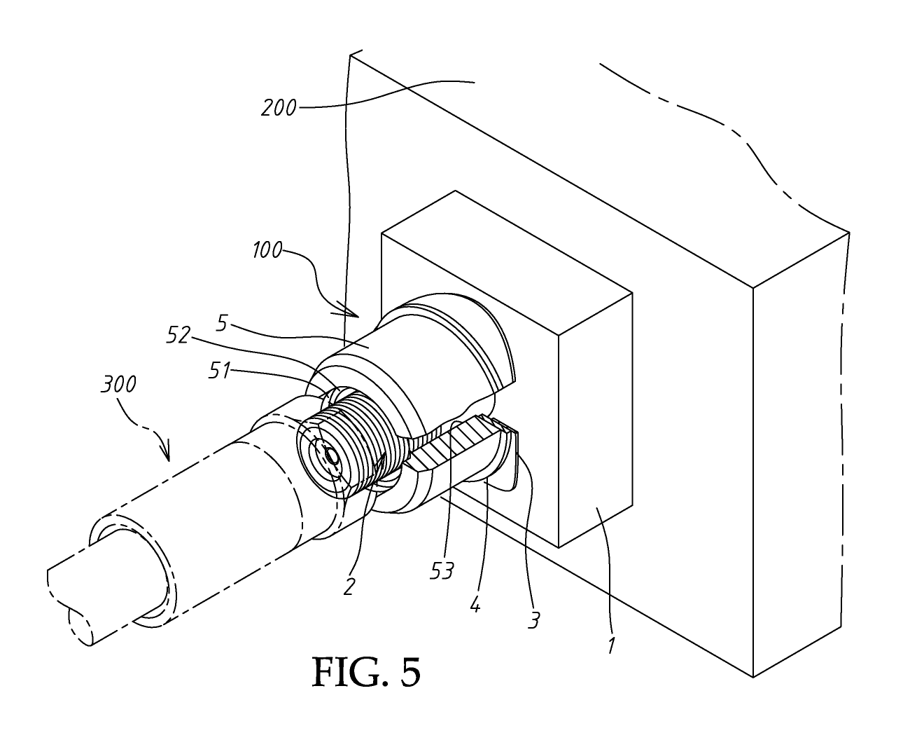

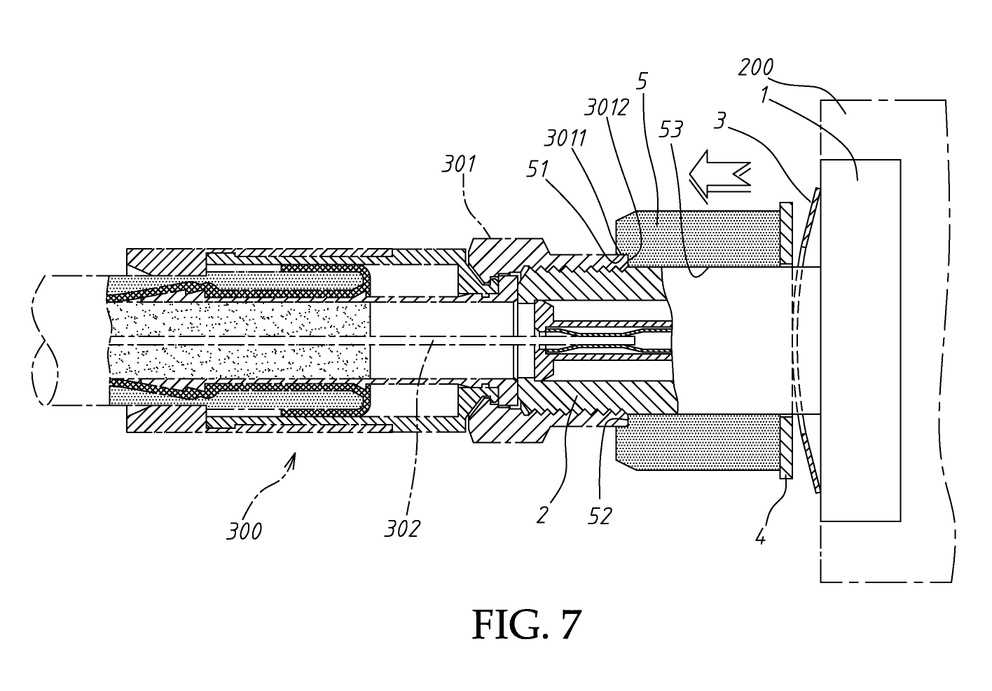

Referring to FIGS. 4-6, the invention provides a water-seal connector 100 for use in a signal receiving device 200, such as splitter, outdoor tap, LNB (Low Noise Block), female splice adapter, or the like, for the fastening of a locknut 301 of a coaxial cable connector 300, as shown in FIG. 7. The water-seal connector 100 mainly comprises a base block 1, a connection component 2, a spring washer 3, a cushion ring 4 and a flexible ring gasket 5.

The base block 1 is mounted in the signal receiving device 200, having an outer wall 11 that protrudes over one side of the signal receiving device 200. The connection component 2 is a cylindrical member extending out of the base block 1, having a smooth surface portion 21 at a proximal end thereof adjacent to the base block 1 for the mounting of the inner hole 53 of the flexible ring gasket 5 water-tightly and an outer thread 22 at a distal end thereof for engagement with the inner thread of the locknut 301 of the coaxial cable connector 300 for enabling a metal center conductor 302 of the coaxial cable connector 300 to be inserted into the connection component 2 (see FIG. 7) for signal transmission. It is to be understood that multiple connection components 2 can be installed in the base block 1 and mounted with one respective spring washer 3, one respective cushion ring 4 and one respective flexible ring gasket 5 for the connection of one respective coaxial cable connector 300.

According to this embodiment, the spring washer 3 is an arched spring member mounted on the connection component 2, having a large side edge of one side thereof 31 stopped against the base block 1 and a small side edge of an opposite side thereof 32 stopped against the cushion ring 4. The cushion ring 4 is also mounted on the connection component 2. It is to be understood that the spring washer 3 can be shaped like a bowl or corrugated ring, or made in any of a variety of other shapes.

The flexible ring gasket 5 is rubber member shaped like a barrel, having a length shorter than the length of the connection component 2. The flexible ring gasket 5 has an inner hole 53 that is slightly smaller than the outer diameter of the smooth surface portion 21 of the connection component 2 so that the inner hole 53 can be press-fitted onto the smooth surface portion 21 tightly. The diameter of the inner hole 53 is also smaller than the outer diameter of the outer race 3011 of the locknut 301 of the coaxial cable connector 300. The flexible ring gasket 5 has its one end kept in contact with the cushion ring 4, and its other end defining an axially inwardly extending annular packing portion 51 and a radially inwardly extending annular stop face 52. The axially inwardly extending annular packing portion 51 defines an inner diameter greater than the outer diameter of the connection component 2, and adapted for receiving the outer race 3011 of the locknut 301 of the coaxial cable connector 300. The radially inwardly extending annular stop face 52 is adapted for stopping against an outer end edge 3012 of the locknut 301 of the coaxial cable connector 300.

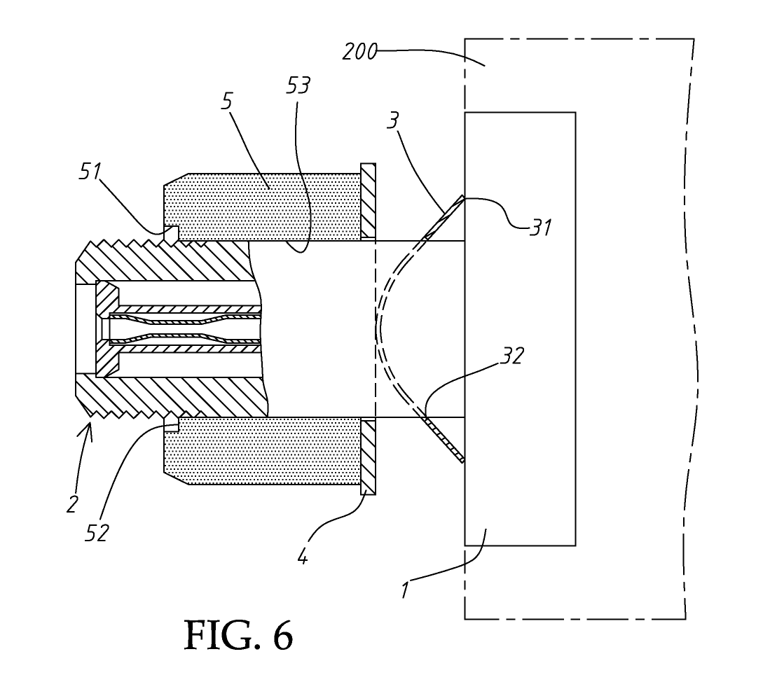

After installation of the water-seal connector 100 in the signal receiving device 200, the spring washer 3, the cushion ring 4 and the flexible ring gasket 5 are stopped against one another, as shown in FIG. 6.

Further, as shown in FIG. 7, when connecting the coaxial cable connector 300 to the water-seal connector 100 at the signal receiving device 200, the locknut 301 of the coaxial cable connector 300 is threaded onto the connection component 2 to force the outer race 3011 of the locknut 301 into axially inwardly extending annular packing portion 51 and to stop the outer end edge 3012 of the locknut 301 against the radially inwardly extending annular stop face 52. At this time, the locknut 301 imparts a pressure to the flexible ring gasket 5 against the cushion ring 4 and the spring washer 3, and the spring washer 3 renders a reaction force to the cushion ring 4 against the flexible ring gasket 5, enhancing connection tightness between the locknut 301 and the flexible ring gasket 5, and therefore the connection area between the locknut 301 and the connection component 2 is water-tightly sealed.

Further, the thread pitch of the inner thread of the locknut 301 of the coaxial cable connector 300 varies between manufacturers (4.29˜6.10 mm subject to FCC (Federal Communications Commission) regulations). When the water-seal connector 100 is connected with the locknut 301 of any commercial coaxial cable connector 300, the axially inwardly extending annular packing portion 51 and radially inwardly extending annular stop face 52 of the flexible ring gasket 5 are respectively stopped against the outer race 3011 and outer end edge 3012 of the locknut 301, and the inner hole 53 is press-fitted onto the smooth surface portion 21 of the connection component 2, and at this time, the locknut 301 imparts a pressure to the flexible ring gasket 5 against the cushion ring 4 and the spring washer 3, and the spring washer 3 renders a reaction force to the cushion ring 4 against the flexible ring gasket 5. Therefore, the water-seal connector 100 fits and seals any commercial coaxial cable connector 300.

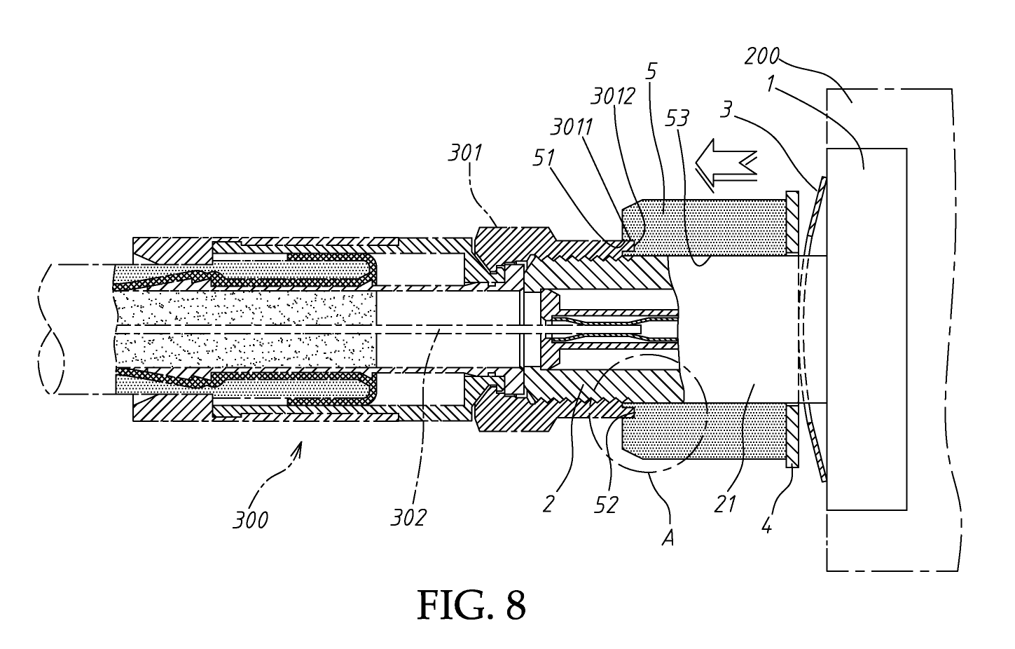

FIG. 8 and FIG. 8A illustrate an alternate form of the present invention for use with a coaxial cable connector 300 of which the inner thread of the e locknut 301 thereof does not extend to the end edge. According to this alternate form, the flexible ring gasket 5 further comprises an inside annular flange 54 perpendicularly outwardly extending from the radially inwardly extending annular stop face 52 in a substantially parallel manner relative to the axially inwardly extending annular packing portion 51 and in flush with the periphery of the inner hole 53. After the locknut 301 is fastened to the connection component 2, the axially inwardly extending annular packing portion 51 and inside annular flange 54 of the flexible ring gasket 5 are respectively wrapped about the outer surface and inner surface of the outer race 3011 of the locknut 301, and the radially inwardly extending annular stop face 52 of the flexible ring gasket 5 is stopped against the outer end edge 3012 of the locknut 301, achieving an excellent water sealing effect.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A water-seal connector used in a signal receiving device for the connection of a locknut of a coaxial cable connector, said locknut defining an outer race and an outer end edge at a front side thereof, the water-seal connector comprising:
a base block mounted in said signal receiving device, said base block having an outer wall protruded over one side of said signal receiving device;
a cylindrical connection component extending out of said base block, said cylindrical connection component comprising a smooth surface portion at a proximal end thereof adjacent to said base block and an outer thread at a distal end thereof for engagement with an inner thread of said locknut of said coaxial cable connector for enabling a metal center conductor of said coaxial cable connector to be inserted into said cylindrical connection component for signal transmission;
a spring washer mounted around said cylindrical connection component, said spring washer having a part of one side thereof stopped against said base block;
a cushion ring mounted around said cylindrical connection component and stopped against a part of an opposite side of said spring washer;
a flexible ring gasket mounted around said cylindrical connection component, said flexible ring gasket having a first end stopped against one side of said cushion ring, a second end opposite to said first end, a length defined between said first end and said second end and being shorter than said cylindrical connection component, an inner hole cut through said first end and said second end and press-fitted onto said cylindrical connection component, an axially inwardly extending annular packing portion defined in said second end and adapted for receiving said outer race of said locknut of said coaxial cable connector and a radially inwardly extending annular stop face defined in said second end and perpendicularly extended from said axially inwardly extending annular packing portion and adapted for stopping against said outer end edge of said locknut of said coaxial cable connector.

2. The water-seal connector as claimed in claim 1, wherein said flexible ring gasket is prepared from rubber.

3. The water-seal connector as claimed in claim 1, wherein said inner hole of said flexible ring gasket has a diameter smaller than the outer diameter of said smooth surface portion of said cylindrical connection component.

4. The water-seal connector as claimed in claim 1, wherein said axially inwardly extending annular packing portion of said flexible ring gasket defines an inner diameter greater than the outer diameter of said connection component and smaller than the outer diameter of said outer race of said locknut of said coaxial cable connector.

5. The water-seal connector as claimed in claim 1, wherein said signal receiving device is selected from the group of splitters, outdoor taps, low noise block and female splice adapters.
